(19) United States
(12) Patent Application Publication
(10) Pub. No.: US 2025/0118067 A1
(43) Pub. Date: Apr. 10, 2025

(54) SYSTEM ENABLEMENT BASED ON IMAGE QUALITY ANALYSIS

(71) Applicant: NEC Laboratories America, Inc., Princeton, NJ (US)

(72) Inventors: Sparsh Garg, Fremont, CA (US); Samuel Schulter, Long Island City, NY (US); Yumin Suh, Santa Clara, CA (US)

(21) Appl. No.: 18/887,626

(22) Filed: Sep. 17, 2024

Related U.S. Application Data
(60) Provisional application No. 63/542,392, filed on Oct. 4, 2023.

(51) Int. Cl. G06V 10/98; G06V 10/26; G06V 10/762; G06V 10/82

(52) U.S. Cl. CPC G06V 10/993; G06V 10/762; G06V 10/82; G06V 10/26

(57) ABSTRACT

Systems and methods include generating a detection output for an image over multiple iterations by applying a dropout randomly to a different convolutional layer of a learning model for each iteration. The detection outputs are clustered, on labels, for each iteration. A total surface area for the clusters is computed over the iteration. A confidence is computed for the image using the total surface area for the clusters as an uncertainty score. A system is disabled if the confidence is below a threshold.

### RELATED APPLICATION INFORMATION

This application claims priority to U.S. Patent Application No. 63/542,392 filed on Oct. 4, 2023, incorporated herein by reference in its entirety.

### BACKGROUND

### Technical Field

The present invention relates to artificial intelligence (AI) systems, and more particularly, to systems and methods that employ image quality to disable use of an AI model.

### Description of the Related Art

Systems which provide detection or segmentation on all types of images have their robustness highly dependent on image quality. As the image quality degrades, the robustness of the model also decreases. For example, many applications rely on images collected from live camera feeds. These live camera feeds can be located outdoors or in other areas where image quality depends on environmental conditions. Changing environmental conditions can include lighting changes, weather changes, density of objects in a camera view, etc. In these situations, detection and/or segmentation results from artificial intelligence systems can become questionable.

Therefore, a need exists for systems and methods which can check image quality and disable the systems and methods if quality degrades beyond a threshold.

### SUMMARY

According to an aspect of the present invention, a computer-implemented method includes generating a detection output for an image over multiple iterations by applying a dropout randomly to a different convolutional layer of a learning model for each iteration. The detection outputs are clustered, on labels, for each iteration. A total surface area for the clusters is computed over the iteration. A confidence is computed for the image using the total surface area for the clusters as an uncertainty score. A system is disabled if the confidence is below a threshold.

According to another aspect of the present invention, a monitoring system, includes a hardware processor; and a memory that stores a computer program which, when executed by the hardware processor, causes the hardware processor to: generate a detection output for an image over multiple iterations by applying a dropout randomly to a different convolutional layer of a learning model for each iteration; cluster, on labels, the detection outputs for each iteration; compute a total surface area for the clusters over the iterations; compute a confidence for the image using the total surface area for the clusters as an uncertainty score; and disable a detection system if the confidence is below a threshold.

According to another aspect of the present invention, a computer program product for monitoring an image data stream, the computer program product comprising a computer readable storage medium having program instructions embodied therewith, the program instructions executable by a hardware processor to cause the hardware processor to: generate a detection output for an image over multiple iterations by applying a dropout randomly to a different convolutional layer of a learning model for each iteration; cluster, on labels, the detection outputs for each iteration; compute a total surface area for the clusters over the iterations; compute a confidence for the image using the total surface area for the clusters as an uncertainty score; and disable a detection system if the confidence is below a threshold.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for monitoring image quality, in accordance with an embodiment of the present invention;

FIG. 2 is a block diagram illustrating a system for monitoring image quality, in accordance with an embodiment of the present invention; and

FIG. 3 is a flow diagram showing methods for monitoring image quality, in accordance with an embodiment of the present invention.

### DETAILED DESCRIPTION OF PREFERRED EMBODIMENTS

In accordance with embodiments of the present invention, monitoring tools and methods are described to evaluate image quality in an image feed. In an embodiment, the image quality is monitored to determine if environmental changes or other factors have influenced the image quality in a negative way. A score of the image quality is maintained as a gauge of the image quality. If the score exceeds a threshold value, which can be adjusted as needed, access to a model, such as an artificial intelligence model can be terminated. As image quality improves, access to the model can be re-enabled.

In accordance with embodiments of the present invention, image processing services, such as face detection, object detection, object segmentation or other image processing services can have results assured in accordance with the image quality. In an embodiment, the image quality score can be output and used as a metric for determining the reliability of the image processing service.

Unlike binary image classification to classify an image as good or bad and rather than training a new AI model, the present embodiments employ a learning model with a dropout threshold added (e.g., a dropout of 0.2 in all the convolutional layers of the learning model) to determine uncertainty scores for an image feed. The uncertainty score can be measured by an AI model output by calculating a cluster surface area for each label predicted by the AI model. The updated AI model can be run with a dropout multiple times, e.g., 50 times, on each image. An average and standard deviation can be computed for the uncertainty scores (e.g., 50) generated by the model AI. Since the dropout layer is randomly placed, features of the AI model are shut down, every time uncertainty scores change. If the uncertainty scores are highly varied then the AI model is not confident on a particular image. If the average of the uncertainty score is high, but standard deviation is low, then the image quality is generally bad. This can be employed to trigger a shutdown of the AI model until quality is restored.

Monitoring the quality of images using the AI model assists in disabling a detection system and can be configured to inform a user in case the quality is not sufficient, e.g., in case of bad weather or a camera fault. In an embodiment, a Monte-Carlo dropout approach can be employed to detect the uncertainties in the results predicted by the system. If the uncertainty is too high, then the system will be disabled.

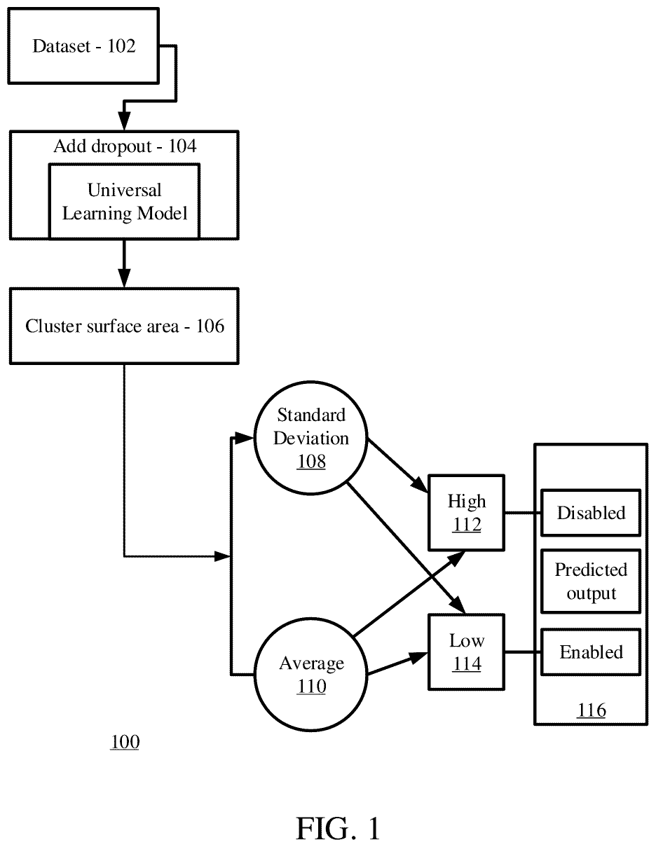

Referring now in detail to the figures in which like-numerals represent the same or similar elements and initially to FIG. 1, a system 100 for monitoring image quality to enable or disable use of detection services (e.g., using an AI model) is shown in accordance with an embodiment. In block 102, a dataset is collected. In an embodiment, the data set can include an image stream collected using one or more cameras. The data set can be collected from a camera that detects crowd size, detects traffic, detects faces or any other type of detection or segmentation service. For example, the dataset can be collected at a bank automated teller machine (ATM) that employs facial recognition. In another example, the dataset can be collected at street level to recognize license plates of passing vehicles. In another embodiment, the data set can be collected for objects detected in a scene. The dataset can include an image or image stream that is submitted to a detection/segmentation system for image processing.

In block 104, a Universal Learning Model can be employed to generate a detection output for all objects detected in the dataset. While all objects can be employed, a subset of objects can also be used if employed consistently. Program code is introduced to randomly select one or more features to dropout (dropout features) of the analysis.

A detection or predicted output (e.g., a labeled output) from a given image as an input from the dataset is achieved by running the Universal Learning Model, which gives bounding boxes for all the objects, a number of times for each image.

A dropout is added and can include adding a value (e.g., a weight) to convolutional layers of a neural network of the Universal Learning Model. In an embodiment, the dropout can include a value of 0.2 added randomly to weaken connections in the neural network. Other dropout values and features can also be employed.

At every iteration, features output from the model will change randomly and will give different outputs every time due to the random placement of the dropout among the convolutional layers. The number of iterations for each image can be selected in accordance with an image quality desired.

In one embodiment, 50 iterations for each image are employed, although any number of iterations can be employed to balance execution time and resources versus quality detection accuracy. The output from the Universal Learning Model includes labeled images from the iterations.

In block 106, at each label, a cluster is created for that label. A total surface area is computed for each cluster. For each iteration run for each image, the cluster surface area is stored as an uncertainty score to determine if the uncertainty score is changing with each iteration. A standard deviation 108 and an average 110 are computed for the number of iterations (e.g., 50) for the surface areas for each image. The total surface area can be computed by accumulating the point of each bounding box for the number (e.g., 50) iterations. The bounding box points form a polygon and by using the points an area of the polygon can be computed. The area of the polygon is the surface area of that label. The surface area is computed for each label predicted by the Universal Learning Model and then the standard deviation 108 and the average 110 for all the surface areas can be employed as an uncertainty score.

Conditions 112 and 114 are set to evaluate whether the standard deviation 108 and the average 110 are high or low relative to respective threshold values for each. Conditions can be implemented in hardware (e.g., logic gates) or software (if-then comparisons).

In block 116, a predicted output or outcome for the detection service is provided from a corresponding AI model in accordance with the assessment of the conditions 112 and 114. For example, if the standard deviation 108 is high, the AI model is not confident for that frame and the system should be disabled. If the standard deviation 108 is low but the average 110 is high, then image quality is bad overall, the system should be disabled. If the standard deviation 108 and the average 110 are low, then the system should be enabled. The standard deviation 108 and average 110 of all the uncertainty scores (e.g., 50) for each image decides whether the system should be disabled or enabled on the basis of threshold comparisons. It should be understood that while the standard deviation and average have been employed to illustrate the present invention, other statistical values and parameters can also be employed instead of or in addition to those described.

Artificial Machine learning systems can be used to predict outputs or outcomes based on input data, e.g., image data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, W₂, . . . . Wₙ₋₁, Wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

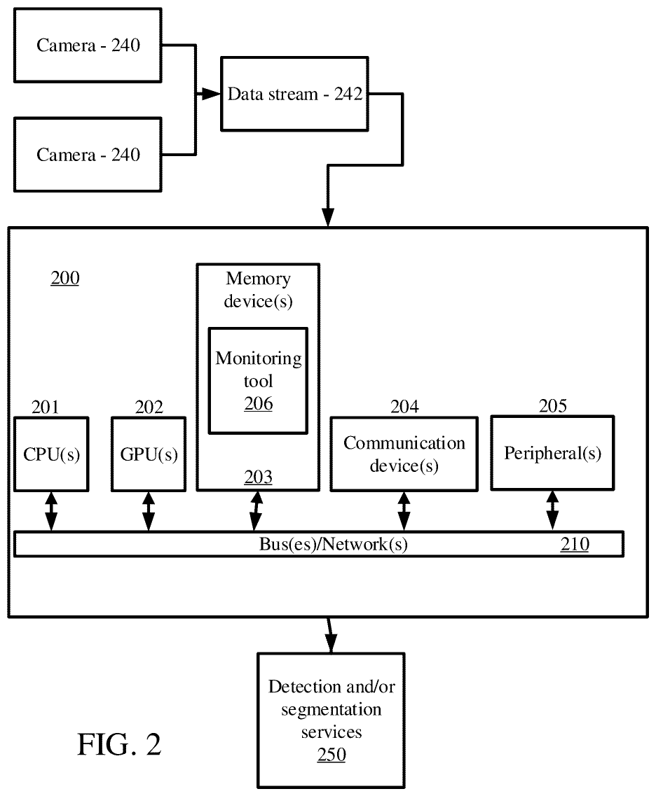

Referring to FIG. 2, a block diagram is shown for an exemplary processing system 200, in accordance with an embodiment of the present invention. The processing system 200 includes a set of processing units (e.g., CPUs) 201, a set of GPUs 202, a set of memory devices 203, a set of communication devices 204, and a set of peripherals 205. The CPUs 201 can be single or multi-core CPUs. The GPUs 202 can be single or multi-core GPUs. The one or more memory devices 203 can include caches, RAMs, ROMs, and other memories (flash, optical, magnetic, etc.). The communication devices 204 can include wireless and/or wired communication devices (e.g., network (e.g., WIFI, etc.) adapters, etc.). The peripherals 205 can include a display device, a user input device, a printer, an imaging device, and so forth. Elements of processing system 200 are connected by one or more buses or networks (collectively denoted by the figure reference numeral 210).

In an embodiment, memory devices 203 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 203 store program code for implementing one or more functions of a monitoring tool 206, as described herein as the system 100 for monitoring image quality. The memory devices 203 can store program code for implementing one or more functions of the monitoring tool 206. In one embodiment, memory devices 203 store program code for monitoring one or more data streams 242. The data streams 242 can include an output of or more cameras 240.

In accordance with embodiments of the present invention, system 200 with the monitoring tool 206 monitors image quality of the data stream(s) 242. In an example, a face recognition application gather face images from the camera 240. However, due to lighting conditions, whether or camera error/failure, etc., image quality can begin to degrade. The monitoring tool 206 determines whether the image quality has degraded beyond a threshold value. Such degradation could have a negative impact. For example, if the face recognition were employed to gain access to a financial account or to open a door to a limited access area, the degradation could permit a false positive match and permit access when access should be denied.

Instead, in accordance with embodiments of the present invention, a degradation in image quality will disable services. For example, a detection and/or segmentation services system 250 (e.g., referred to as a detection system) can include an AI model or other system, which is to be accessed to provide services, e.g., the face recognition service. The detection and/or segmentation services system 250 can include a server, the Cloud or other network that provides services to an end user or client. In the event of image quality degradation beyond a threshold, the monitoring tool 206 can disable access to the service that the detection and/or segmentation services system 250 would otherwise provide. In this way, the monitoring system can protect against false positives, in the case of the face recognition access example.

When the monitored image quality returns in comparison with the threshold, the monitoring tool 206 while re-enable access to the service that the detection and/or segmentation services system 250 would otherwise provide.

Of course, the processing system 200 may also include other elements (not shown), as readily contemplated by one of skill in the art, as well as omitting certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 200 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 200.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

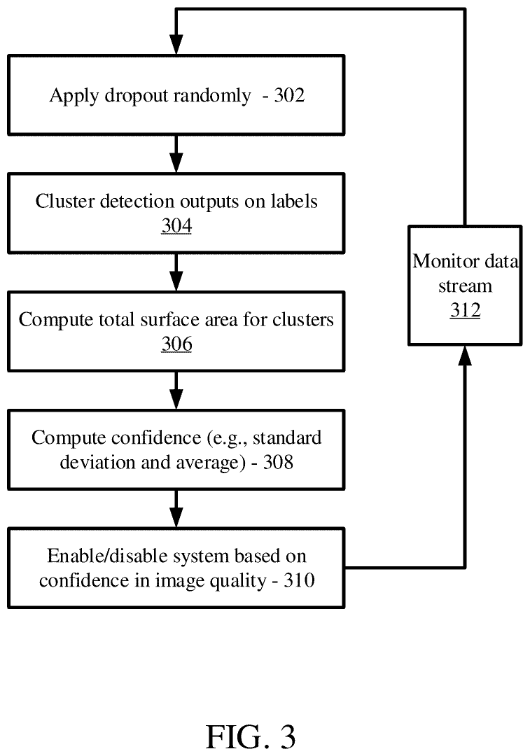

Referring to FIG. 3, a computer-implemented method for monitoring image quality is described and shown in accordance with embodiments of the present invention. In block 302, a detection output is generated for an image over multiple iterations by applying a dropout randomly to a different convolutional layer of a learning model for each iteration. This generates different outputs for each iteration creating a statistical field when the labeled results are clustered. The detection output can include employing a Universal Learning Model to generate prediction results. The image can be collected from a camera or other imaging device (e.g., ultrasound, infrared, etc.).

In block 304, clusters are formed using labels for the detection outputs for each iteration. In block 306, a total surface area is computed for the clusters over the iterations. This provides total surface area values for each of the iterations for a given image. In block 308, a confidence is computed for the image using the total surface area for the clusters as an uncertainty score. Computing the confidence for the image can include computing a standard deviation and average over the total surface area for the clusters over the iterations. Other parameters can also be employed.

In an embodiment, when the standard deviation and the average are low relative to the threshold, the detection system is disabled. When the standard deviation and the average are high relative to the threshold, the detection system is enabled (or re-enabled).

In block 310, a system, e.g., a detection system or other system is enabled/disabled depending on the confidence to threshold comparison. For example, if the confidence is below a threshold the detection system is disabled. The detection system can include a detection/segmentation system that provides a permission in accordance with content of the image. The permission can include providing access to a location, a financial account or system, or any other permission. The detection system can provide a command or other signal to provide an action in accordance with the enable/disable signal. In block 312, the monitoring system can monitor a data stream of images to detect changes in image quality. The monitoring system can function as a sensor and a switch triggered in accordance with image quality.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
generating detection outputs for an image over multiple iterations by applying a dropout randomly to a different convolutional layer of a learning model for each iteration;
clustering, on labels, the detection outputs for each iteration;
computing a total surface area for clusters over the iterations;
computing a confidence for the image using the total surface area for the clusters as an uncertainty score; and
disabling a system if the confidence is below a threshold.

2. The method of claim 1, wherein computing the confidence for the image includes computing a standard deviation and average over the total surface area for the clusters over the iterations.

3. The method of claim 2, wherein in response to the standard deviation and the average being low relative to the threshold, the system is disabled.

4. The method of claim 2, wherein in response to the standard deviation and the average being high relative to the threshold, the system is enabled.

5. The method of claim 1, wherein generating the detection outputs includes employing a Universal Learning Model.

6. The method of claim 1, wherein the image is collected from a camera.

7. The method of claim 1, wherein the system includes a detection/segmentation system that provides a permission in accordance with content of the image.

8. The method of claim 1, further comprising monitoring a data stream of images to detect changes in image quality.

9. A monitoring system, comprising:
a hardware processor; and
a memory that stores a computer program which, when executed by the hardware processor, causes the hardware processor to:
generate detection outputs for an image over multiple iterations by applying a dropout randomly to a different convolutional layer of a learning model for each iteration;
cluster, on labels, the detection outputs for each iteration;
compute a total surface area for clusters over the iterations;
compute a confidence for the image using the total surface area for the clusters as an uncertainty score; and
disable a detection system if the confidence is below a threshold.

10. The monitoring system of claim 9, wherein the confidence computed for the image includes a standard deviation and average over the total surface area of the clusters over the iterations.

11. The monitoring system of claim 10, wherein in response to the standard deviation and the average being low relative to the threshold, the detection system is disabled.

12. The monitoring system of claim 10, wherein in response to the standard deviation and the average being high relative to the threshold, the detection system is enabled.

13. The monitoring system of claim 9, further comprising a Universal Learning Model to generate the detection outputs.

14. The monitoring system of claim 9, further comprising a camera to collect the image.

15. The monitoring system of claim 9, wherein the detection system provides a service in accordance with content of the image.

16. The monitoring system of claim 9, wherein the monitoring system monitors a data stream of images to detect changes in image quality.

17. A computer program product for monitoring an image data stream, the computer program product comprising a computer readable storage medium having program instructions embodied therewith, the program instructions executable by a hardware processor to cause the hardware processor to:
generate detection outputs for an image over multiple iterations by applying a dropout randomly to a different convolutional layer of a learning model for each iteration;
cluster, on labels, the detection outputs for each iteration;
compute a total surface area for clusters over the iterations;
compute a confidence for the image using the total surface area for the clusters as an uncertainty score; and
disable a detection system if the confidence is below a threshold.

18. The computer program product of claim 17, wherein the computer program product further causes the hardware processor to compute for the image, the confidence, which includes a standard deviation and average over the total surface area of the clusters over the iterations.

19. The computer program product of claim 17, wherein the detection system provides a service in accordance with content of the image.

20. The computer program product of claim 17, wherein the computer program product further causes the hardware processor to monitor a data stream of images to detect changes in image quality.
